(19) United States
(12) Patent Application Publication
(10) Pub. No.: US 2012/0271650 A1
(43) Pub. Date: Oct. 25, 2012

(54) COMPUTER IMPLEMENTED SYSTEM AND METHOD FOR CONNECTING PATIENTS WITH PRACTITIONERS

(75) Inventors: Min S. Ahn, Hopkinton, MA (US); Douglas S. Scherr, Scarsdale, NY (US); Eric Shashoua, Barrington, RI (US)

(73) Assignees: Douglas S. Scherr, Scarsdale, NY (US); Min S. Ahn, Hopkinton, MA (US)

(21) Appl. No.: 13/450,160

(22) Filed: Apr. 18, 2012

Related U.S. Application Data
(60) Provisional application No. 61/476,525, filed on Apr. 18, 2011.

(51) Int. Cl. G06Q 50/22

(52) U.S. Cl. 705/2

(57) ABSTRACT

Computer-implemented systems and methods connect users interested in one or more cosmetic procedures with a plurality of practitioners. Using an application of the system, each user submits a request, which includes one or more photographs of himself/herself and a summary of the user's desired goals. The request is transmitted to the practitioners. The practitioners receive the request, optionally use a morphing application provided by the application to manipulate the photograph(s) to mimic the user's desired results, and send a response to the user. Once the user receives the responses, the user can choose to continue corresponding with one or more practitioners to fine-tune or learn more about the projected results, which again may proceed by the exchange of morphed photographs. Once the user is satisfied with one or more of the projected results, the user can send an appointment request to schedule an in-person appointment with one or more practitioners.

### CROSS REFERENCE TO RELATED APPLICATION

This application claims priority to U.S. Provisional Patent Application Ser. No. 61/476,525, filed Apr. 18, 2011, which is hereby incorporated herein by reference in its entirety for all purposes.

### FIELD OF THE INVENTION

The present invention relates generally to a computer implemented system and method for connecting patients with practitioners, and more particularly to a cloud-based system and method that enables users to connect with a plurality of practitioners before scheduling an in-person appointment.

### BACKGROUND

For many years, people have sought the advice of plastic surgeons and other practitioners to change their appearance. Some of these potential patients would seek recommendations from friends, family, coworkers, etc. Others may look to the phone book or use internet searches to find a practitioner with a certain specialty. Once the potential patient had one or more names of practitioners, the person would usually schedule appointments with those practitioners for in-person consultations. At the consultation, the person would learn if his/her desired results are achievable and if the practitioner is a good match. Such a process of interviewing practitioners can be time-consuming and costly, especially when the person is interviewing several practitioners.

Thus, there exists in the industry a need for a system and method that efficiently connects potential patients with practitioners.

### SUMMARY

Generally described, in an example embodiment, the present invention provides a cloud-based system that enables users to choose from among a plurality of medical practitioners. The system includes a plurality of cloud-based computer servers connected to the internet and in communication with one another and a user device connected to the plurality of computer servers via the internet, wherein computer-executable instructions reside on one or more of the servers. The computer-executable instructions include instructions for receiving a request from a user device to change the appearance of at least one body part of the user; sending the user's request to the plurality of medical practitioners via the internet; receiving from at least one of the plurality of medical practitioners a response to the request; and sending the response to the user. Preferably, the request includes a photograph of the body part and text describing what changes are desired. The response from at least one of the practitioners includes a morphed image that is a morphed version of the user's submitted photograph to show the user's desired changes and can optionally include a comment from the practitioner.

An example method of connecting users with one or more medical practitioners prior to meeting in person includes the steps of receiving a photograph over the internet from a user with a request to modify at least a portion of the photograph to achieve a desired goal; transmitting the photograph and the desired goal to a plurality of medical practitioners; providing a plurality of morphing tools to the plurality of medical practitioners to use to modify the photograph into the morphed version; receiving a response from at least one practitioner, wherein the response comprises at least one of a morphed version of the user's photograph and a comment; and transmitting the response to the user.

In another example embodiment, a computer-implemented system provides a user a remote consultation from a medical practitioner. The system includes logic for saving a request for the remote consultation from the user in a portion of a centralized database connected to the internet, wherein the portion of the centralized database is accessible by the medical practitioner and the user. The request includes at least one photograph of the user and at least one change desired by the user. The system further includes logic for providing the practitioner with tools for manipulating the photograph into a morphed electronic image, wherein the morphed electronic image reflects the desired change and wherein the tools are accessed through an application via the internet, and logic for storing the morphed electronic image in the portion of the centralized database accessible by the user and the medical practitioner.

In another example embodiment, a computer program being embodied on a computer-readable medium can be used to connect users with a plurality of practitioners. The computer program includes a plurality of code segments, including a first code segment for receiving a request from each user; a second code segment for transmitting each request to a plurality of practitioners; a third code segment for transmitting responses from at least two practitioners to each user; and a fourth code segment for receiving a selection from each user of a preferred practitioner for future contact. Preferably, each request includes an image of the user and a description of the desired change to the image, and each response includes at least one of a modified photograph and a comment.

In another example embodiment, a communications method for exchanging messages over the internet between a practitioner and a plurality of patients includes the step of receiving a request from the practitioner to access a centralized database connected to the internet, wherein the centralized database has stored thereon information for the plurality of patients. The information includes contact information for the plurality of patients and a first photograph of each of the plurality of patients, wherein the first photograph shows the patient prior to a particular procedure. The method further includes the steps of receiving a selection from the practitioner of contact information for one or more patients to whom a message will be sent, and sending the message to the one or more patients, the message including a second photograph, wherein the second photograph shows projected results for the particular procedure.

These, and other features and advantages of the present invention will become apparent from the following description, drawings and claims.

### BRIEF DESCRIPTION OF THE DRAWINGS

FIG. 1 is a representation of a computer-implemented system for connecting patients with practitioners according to an example embodiment of the present invention.

FIG. 2 shows an example of a user interface of the system of FIG. 1.

FIG. 3 shows an example of a practitioner interface of the system of FIG. 1.

FIGS. 4A, 4B and 4C are a flowchart representation of a method of connecting patients with practitioners according to an example embodiment of the present invention and using the system of FIG. 1.

FIG. 5 shows an example of a screenshot of a morphing application of FIG. 1, and showing a push morphing tool.

FIG. 6 shows an example of a screenshot of the morphing application of FIG. 1, and showing a lip enhancement morphing tool.

FIG. 7 shows an example of a screenshot of the morphing application of FIG. 1, and showing a shrink morphing tool.

FIG. 8 shows an example of a screenshot of the morphing application of FIG. 1, and showing an enlarge morphing tool.

FIG. 9 shows an example of a screenshot of the morphing application of FIG. 1, and showing a clone morphing tool.

FIG. 10 shows an example of a screenshot of the morphing application of FIG. 1, and showing a draw morphing tool.

FIG. 11 shows an example of a screenshot of the morphing application of FIG. 1, and showing a smooth morphing tool.

FIGS. 12 and 13 show examples of screenshots of a beauty guide application of FIG. 1.

FIG. 14 shows an example of a screenshot of a beauty questionnaire application of FIG. 1.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions, or parameters described and/or shown in the specification and drawing figures. The terminology used in the specification is for the purpose of describing particular embodiments by way of example only and is not intended to be limiting of the claimed invention. Any and all patents and other publications identified in the specification are incorporated by reference as though fully set forth herein.

Also, as used in the specification and the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

Generally described, the present invention provides a cloud-based system that enables users, e.g., potential patients for a cosmetic surgery or procedure, to obtain information from a plurality of medical practitioners about the projected results for a particular cosmetic procedure. For example, a user can upload one or more photographs of himself/herself to an application in the cloud-based system and request that the photograph(s) be sent to several practitioners along with a summary of what the user wants to accomplish. For example, the user may want to have a rhinoplasty and may request that his nose be somewhat smaller and have a particular shape. That information and the user's photograph(s) are transmitted within the cloud-based system to a plurality of practitioners. The practitioners can accept or deny the request. If accepted, the practitioner can then use a morphing application provided in the cloud-based system to manipulate the photograph(s) of the user to provide projected results that mimic the user's desired results and send the manipulated photograph(s) to the user. Optionally, the practitioner may include comments with the photograph(s). Once the user receives the responses from the practitioners, the user can choose to continue corresponding with one or more practitioners to fine-tune the projected results. Once the user is happy with one or more of the projected results, the user can schedule an in-person appointment with the practitioner using the cloud-based system.

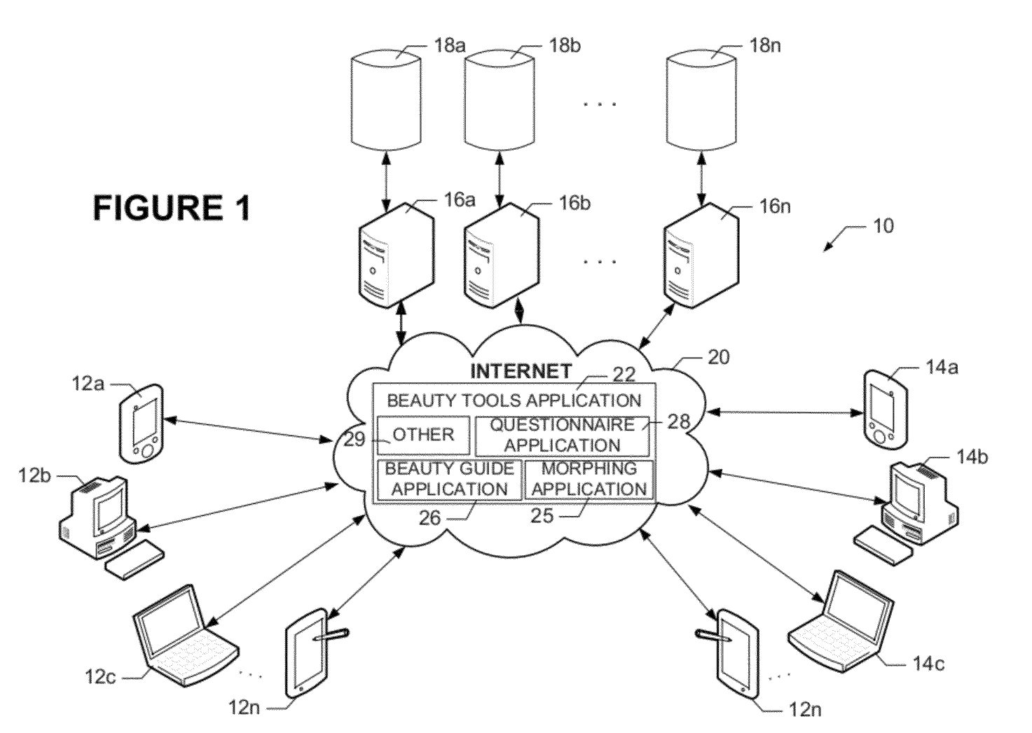

Referring now to FIG. 1, a representation of a computer-implemented system 10 for connecting potential patients (herein sometimes referred to as “users” of the system) with medical practitioners. As used herein in the example embodiments, the term “medical practitioner” is used to refer to licensed practitioners such as a physician, physician's assistant, or nurse. However, it is contemplated that in other embodiments, other practitioners can include estheticians and other persons working at medical spas. Generally, each potential patient/user is looking to modify some part of his or her body with a cosmetic procedure. As used herein, the term “cosmetic procedure” broadly encompasses all procedures and surgeries (including reconstructive surgeries) that enhance one's image, including, but not limited to augmentations or reductions (e.g., rhinoplasty, breast augmentations/reductions, etc.), chemical peels, laser treatments, liposuction, etc.

The system 10 includes a plurality of user devices 12a-12n, a plurality of practitioner devices 14a-14n, and a plurality of servers 16a-16n each in communication with at least one database 18a-18n. The user and practitioner devices 12a-12n and 14a-14n can access the databases 18a-18n over the internet 20. The user devices 12a-12n, the practitioner devices 14a-14n, and the servers 16a-16n are all communicatively coupled to the internet 20 (or “cloud”). Such connections to the internet 20 may be achieved via a telephone line using a modem (POTS), Bluetooth, WiFi, cellular, optical, satellite, RF, Ethernet, magnetic induction, coax, RS-485, or the like. In other embodiments, in lieu of the internet, other networks such as a local area network (LAN) or a wide area network (WAN).

The user devices can include smart phones 12a, personal computers 12b, laptops (or notebooks, tablets, or other handheld computers) 12c, personal digital assistants (PDAs) 12n, pocket PCs (not shown), palm devices (not shown), pagers (not shown), WAP devices (not shown), and non-WAP devices (not shown), although the present invention contemplates the use of any electronic device capable of being communicatively coupled to the internet 20. Optionally, the user devices 12a-12n may include an associated camera, as is common with these types of devices. Similarly, the practitioner devices can include smart phones 14a, personal computers 14b, laptops (or notebooks, tablets, or other handheld computers) 14c, personal digital assistants (PDAs) 14n, pocket PCs (not shown), palm devices (not shown), pagers (not shown), WAP devices (not shown), and non-WAP devices (not shown), although the present invention contemplates the use of any electronic device capable of being communicatively coupled to the internet 20. Each of the user devices 12a-12n and practitioner devices 14a-14n typically has applications and can have a local database. The processing components of the user and practitioner devices are generally well-known and will not be described herein.

The servers 16a-16n can each include applications, including a beauty tools application 22, that is available to the user and practitioner devices 12a-12n and 14a-14n via the internet 20, and one or more databases 18a-18n that can be accessed by the user and practitioner devices 12a-12n and 14a-14n via connections over the internet 20. The servers 16a-16n can run administrative software for the cloud-based beauty tools application 22 and control access to itself and the databases 18a-18n.

The servers 16a-16n can each include, but not limited to, one or more PCs, workstations, laptops, PDAs, palm devices, and the like. Generally, in terms of hardware architecture, the servers 16a-16n include a processor, memory, and one or more input and/or output (I/O) devices (or peripherals) that are communicatively coupled via a local interface. The local interface can be, for example but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The beauty tools application 22 can have several functional tools. The beauty tools application 22 can include interfaces—a first subsystem or interface that is typically accessed and used by the users (e.g., potential patients) and a second subsystem or interface that is typically accessed and used by the practitioners. In a typical commercial embodiment, the beauty tools application 22 is embodied on a website with multiple web pages.

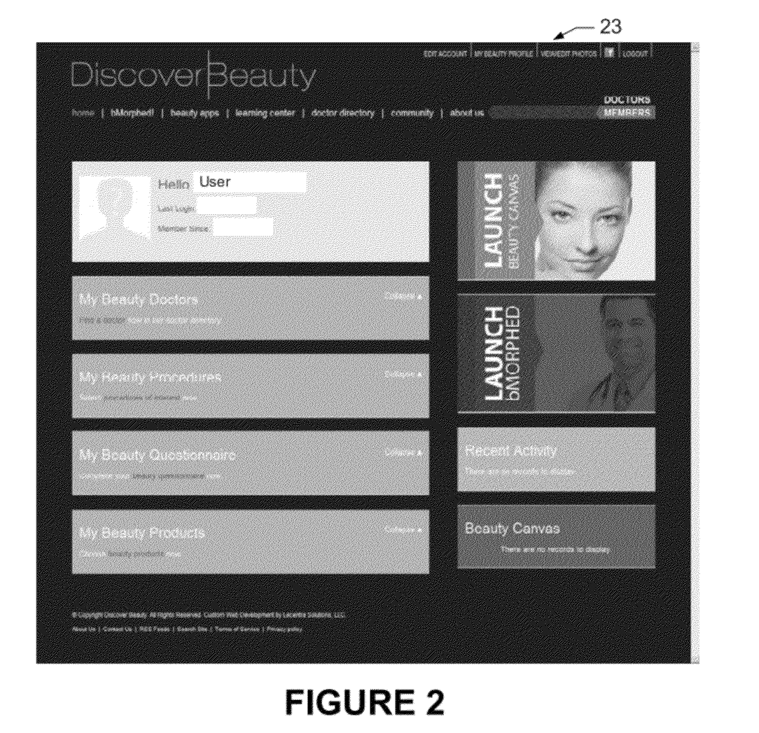

Preferably, each user registers to use the online beauty tools application 22 (such as by creating a unique username and password). An example embodiment of the user account 23 (e.g., a user interface) is shown in FIG. 2. By doing so, the user can be provided a customized experience through the use of a user account 23. As part of the user account 23, the user can store information about himself/herself along with one or more photographs. Such information can include the user's name, age, gender, email, and phone number. This information and photographs are stored in one or more of the databases 18. Moreover, the user account 23 can include links to any of the beauty application tools discussed herein. Additionally, a listing of the user's preferred practitioners and contact information can be stored in the user account 23, as well as a listing of preferred beauty products. Preferably, the user account 23 can be accessed by only the user (such as through use of a password). Alternatively, the user's account, or select portions thereof, can be accessed by the practitioners and/or other users of the system 10.

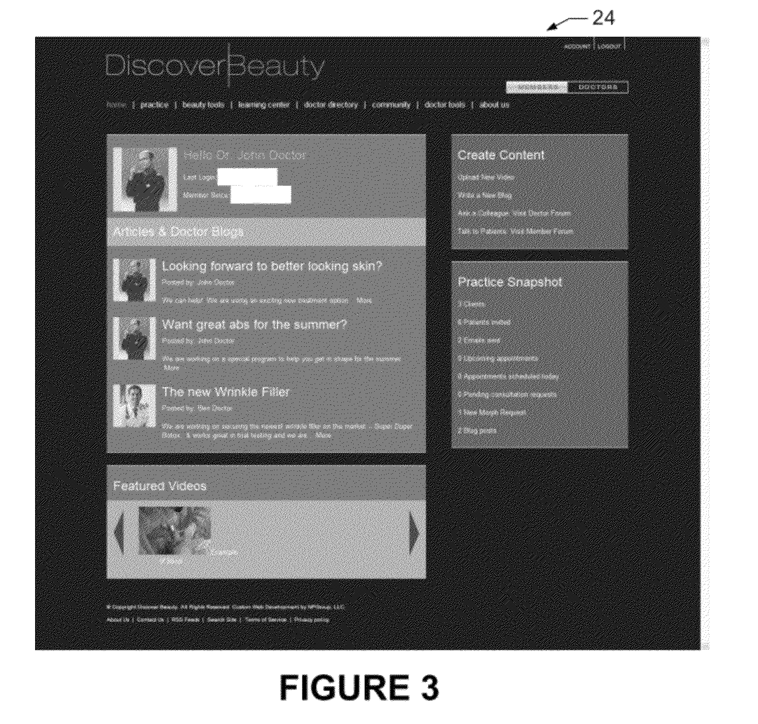

Also preferably, each practitioner registers to use the online beauty tools application 22 (such as by creating a unique username and password). An example embodiment of the practitioner account 25 (e.g., the practitioner interface) is shown in FIG. 3. By doing so, the practitioner can be provided a customized experience through the use of a practitioner account 25. As part of the practitioner account 25, the practitioner can manage patients and appointments. For example, the practitioner account 25 can include a practice page, as discussed in more detail below.

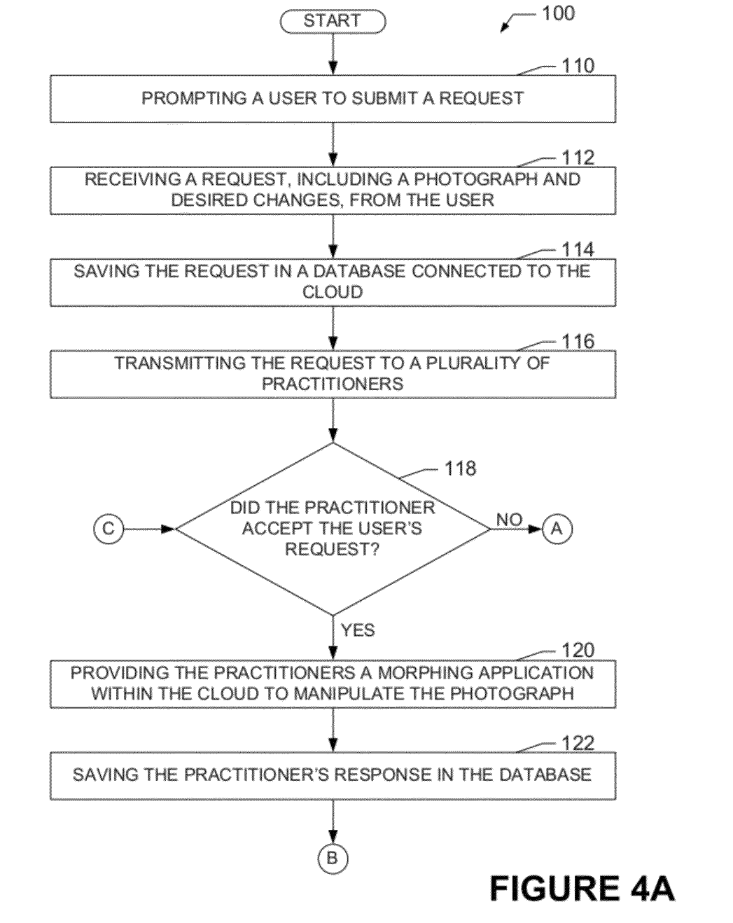

When a user logs into his/her user account in the beauty tools application 22, the user can select a first tool that allows the user to request one or more practitioners to manipulate or morph a photograph of the user to mimic the desired results of a particular cosmetic procedure. In other words, the beauty tools application 22 can provide the user the ability to send a photograph to a selected practitioner or a group of practitioners to morph the photograph to reflect the anticipated results of a desired cosmetic procedure, as described generally with reference to the method 100 of FIGS. 4A-4C. At step 110, the application 22 prompts the user to submit a request. The request can include a photograph and a description of what the user would like to accomplish. As part of this prompt, the application 22 can prompt the user to select a photograph that is either stored locally on the user device 12 or in one of the databases 18 (if the user previously uploaded a photograph to the user account, which is stored in the database) to send to one or more practitioners. The user can be prompted to browse files on the user device 12 until the desired photograph is found and selected, or the user can be prompted to select an image from its saved images in the user account. Alternatively, the user can be prompted by the application 22 to take a picture of himself/herself with a camera associated with his/her user device. Thus, the application 22 could capture the image and save it in the database 18. Optionally, the application 22 can provide instructions for taking the picture such as indicating whether the user should submit a front view and/or profile view.

The user can also be prompted to describe the type of procedure desired and what results the user would like to accomplish as well as be prompted to provide a brief history that includes some basic information about the user's health. Optionally, the application 22 can prompt the user to select one or more practitioners to whom the request will be transmitted. A practitioner directory can be provided to the user that includes a search engine for the user to search for the practitioner by any of variety of parameters such as practitioner name, geographical location (e.g., within 50 miles of the user's home), gender preference, desired procedure, etc. The directory can also include a listing by state of licensed practitioners and/or a listing by procedures. In a typical commercial embodiment, the selection of practitioners is limited to those practitioners who have previously registered to use the application 22. However, in other embodiments, the request could be transmitted to practitioners not registered to use the application 22 such as sending a request via email outside of the application 22. Still alternatively, the application 22 can include preset criteria for selecting which practitioners to transmit the request. Such can be the default and can occur absent user selection. The user completes and submits this request, and this request is received by the application 22 at step 112.

At step 114, the application 22 saves the request in one or more of the databases 18. At step 116, the application 22 transmits the request to the plurality of practitioners. Preferably, the request can be transmitted to each practitioner account. In a typical commercial embodiment, the user's identity and contact information is not included with the request, although in other embodiments, the user's identity and contact information can be provided. Optionally, the application 22 sends a notification email to each practitioner indicating that there is a new user request pending. Alternatively, the user request can be transmitted to the practitioners via email instead of the practitioner accounts. Generally, each practitioner will respond to the request, and at decision 118, the application 22 receives a response indicating whether the practitioner has accepted the request. If the practitioner has not accepted the request, the method 100 advances to step 140, where the application 22 transmits a message to the user account that the practitioner had declined to accept this request and the method 100 ends with respect to that particular practitioner. For those practitioners who did accept the user request at decision 118, the method advances to step 120, where the application 22 provides the practitioners a morphing application 25 with a suite of morphing tools within the cloud to manipulate the photograph. The morphing tools can include a push tool, a lip enhancement tool, a shrink tool, an enlarge tool, a clone tool, a draw tool, a smooth tool, a commenting tool, and a crop tool, although the present invention contemplates the use of additional or fewer morphing tools. Icons within a menu can be used to pictorially represent the functionality of each morphing tool. In one example embodiment, the menu appears to the left of the image to be manipulated/morphed, although in other embodiments, the menu can appear at any location on the screen. Scrolling over an icon can display the name of the tool. Upon selection of any of the morphing tools, a toolbar of additional tools can appear.

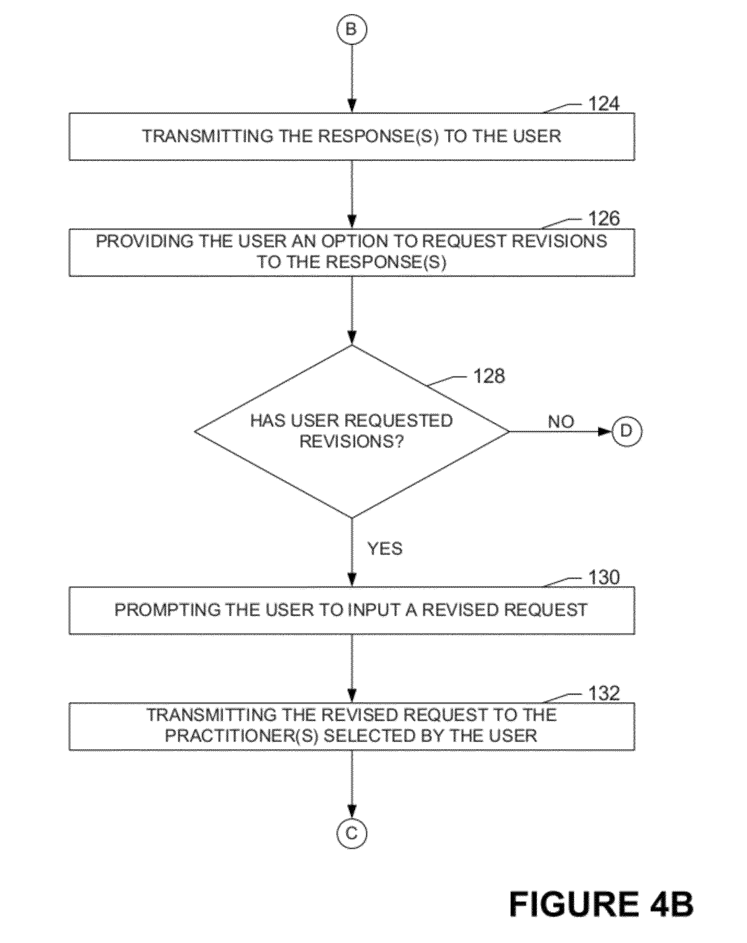

The first morphing tool, the push tool 30, is shown in more detail in FIG. 5. This tool allows the practitioner to select a portion of the image in an enclosed circle and to “push” that portion of the image in the enclosed circle. In a profile view (e.g., side-view picture), the practitioner could, for example, use the push tool to “push” the nose inwardly, thereby simulating the results of a rhinoplasty to reduce the size of the nose. Also, as shown in FIG. 5, a second toolbar can appear when the icon for the push tool is selected. This toolbar allows the practitioner to designate the size of the area to be pushed. In other words, the circular area can be made larger (by selecting a larger block that can be located towards the top of the toolbar) or smaller (by selecting a smaller block that can be located towards the bottom of the toolbar).

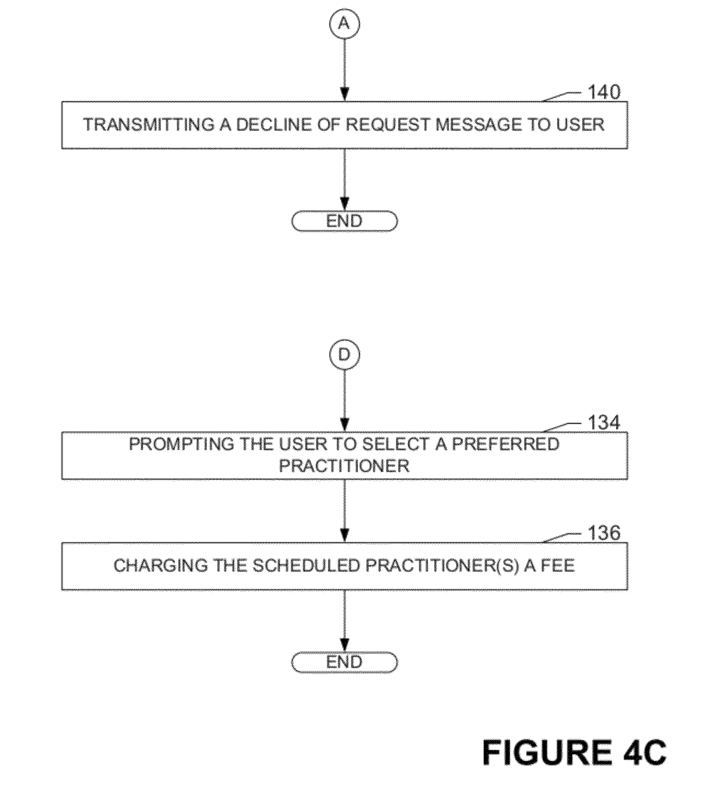

The second morphing tool 32, the lip enhancement tool, can be used to enhance the lips of the photograph, as shown in FIG. 6. The lip enhancement tool prompts the practitioner to position the cursor within the center of the lips. Once the application 25 receives an indication that the cursor is within the center of the lips (e.g., such as through one or two clicks of the mouse from the practitioner device 14), the application 25 displays an outline of the lips. The displayed outline may not align with the lips on the photograph, so the application 25 provides the practitioner the ability to resize and reshape the lip outline so that the final outline closely matches the contours of the lips in the image. Once done, the application 25 receives an indication that the lip outline is set, e.g., when the practitioner clicks a “set lips” button. Once that occurs, the practitioner can select the desired fullness of the lips as he/she scrolls up and down the toolbar (e.g., scrolling up the toolbar can give more fullness, while scrolling down the toolbar can give less fullness).

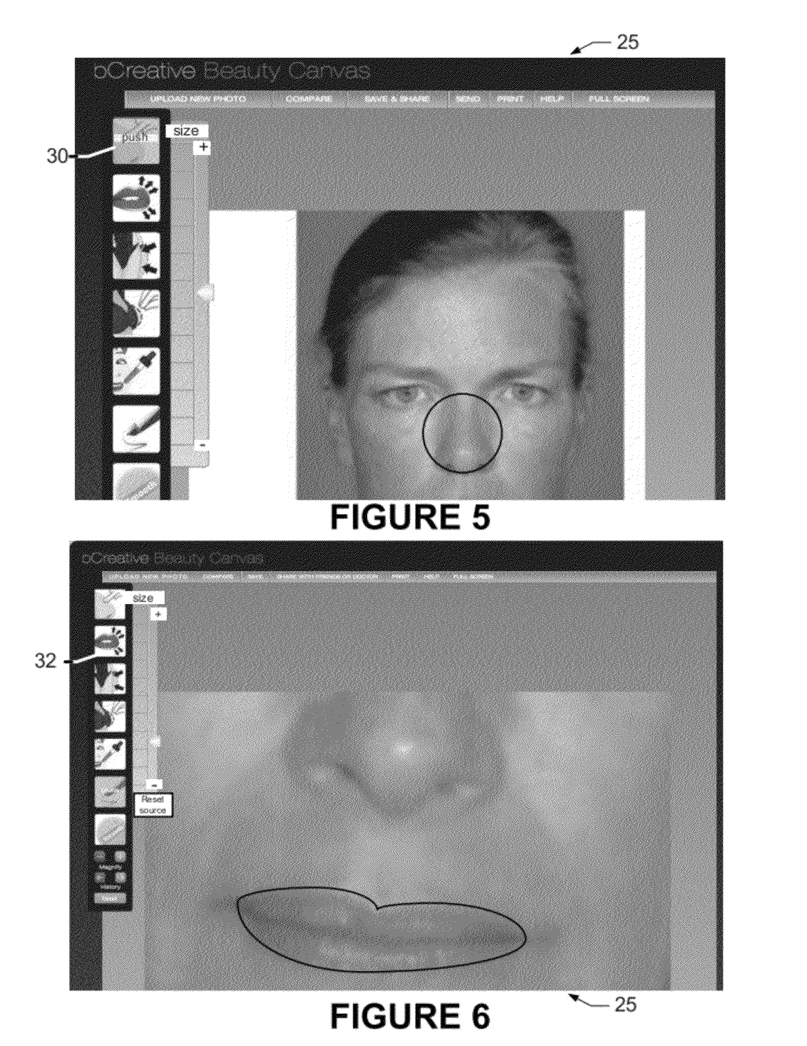

The third morphing tool, the shrink tool 34, can be used to reduce or shrink a portion of an image, as shown in FIG. 7. This tool allows the practitioner to “shrink” a portion of the image in an enclosed circle. The enclosed circle is similar to that of the push tool. The toolbar allows the practitioner to enlarge or shrink the size of the circle (e.g., scrolling up the toolbar can yield a larger enclosed area to shrink). Once the desired size of the circle is selected and placed on the desired area of the photograph, the practitioner can click the mouse, for example, to reduce/shrink the contents of the enclosed circle.

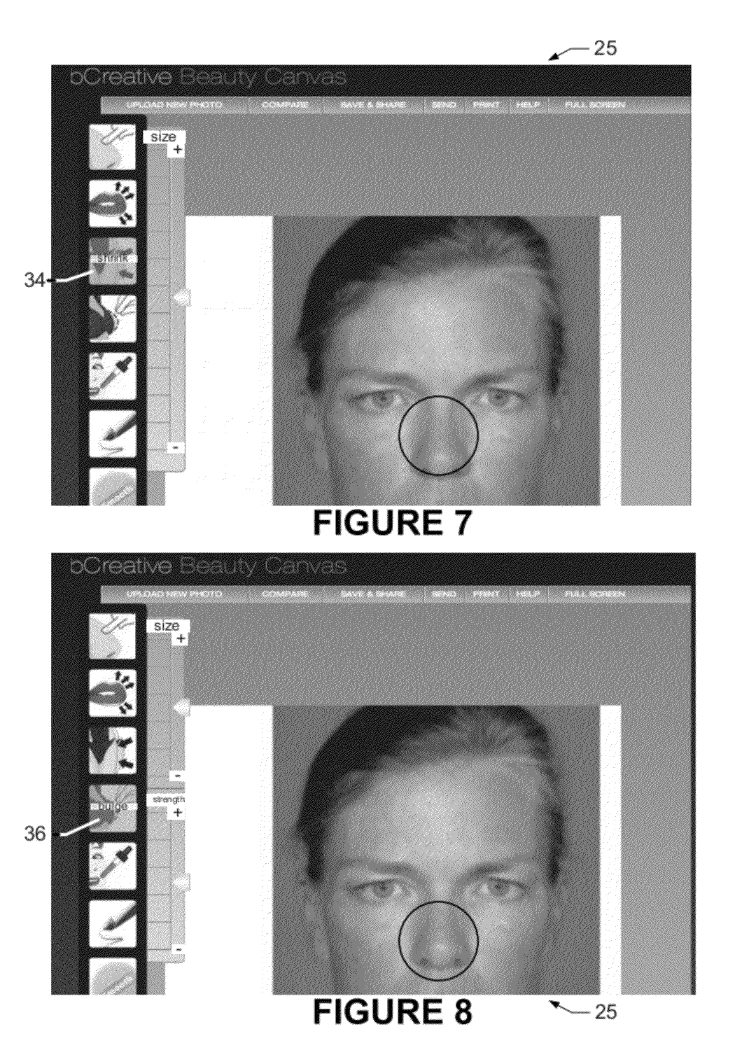

The fourth tool, the enlarge tool 36, can be used to enlarge or bulge a portion of the image, as shown in FIG. 8. This tool operates similarly to the shrink tool, but the contents of the enclosed circle are enlarged rather than shrunk. In addition to the allowing the practitioner to enlarge the contents of the enclosed circle, this tool also has an optional “strength” feature. A stronger strength means the more the enclosed area is bulged, while a weaker strength means the less the enclosed area is bulged.

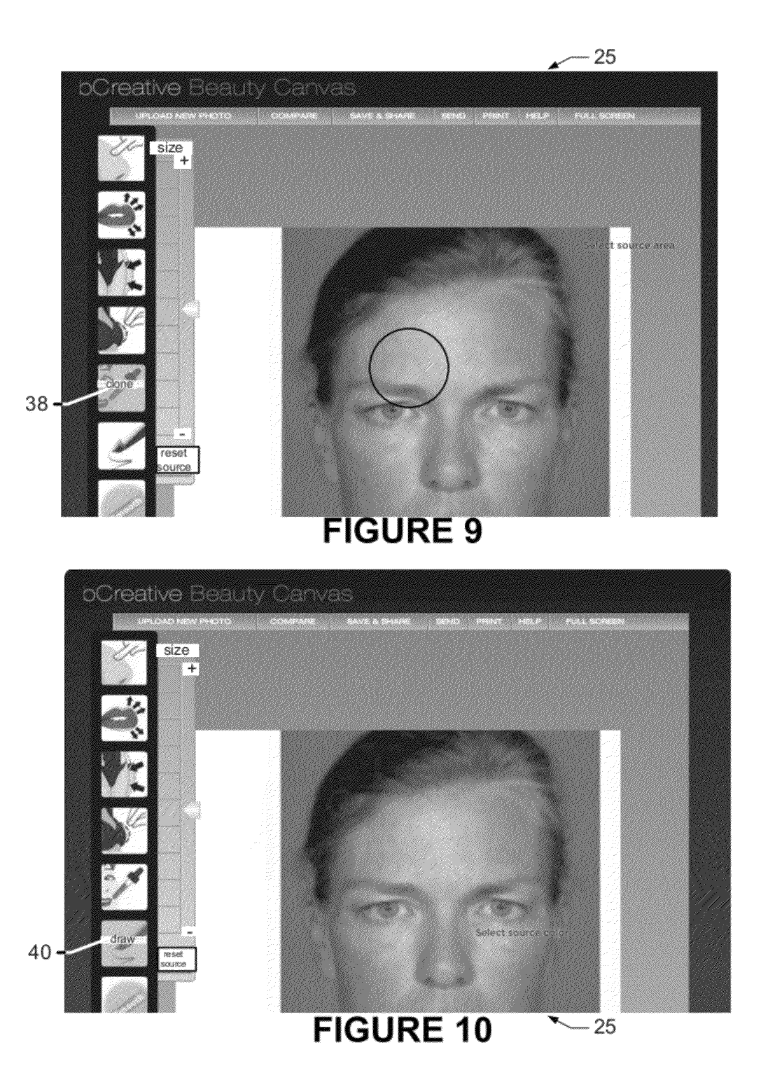

The fifth morphing tool 38, the clone tool, can be used to clone a portion of the image, as shown in FIG. 9. For example, if the practitioner feels that a part of the image is not symmetrical or wants to substitute one area of the image with another area of that image, the practitioner can do so with this clone tool. Upon launch of the clone tool, an enclosed circle appears that can be made larger or smaller with a second toolbar. Once the desired size is selected, the practitioner can select a portion of the image within the enclosed circle, thereby copying that portion, and can paste the copy onto the image in another location. In other words, the practitioner can copy one part of the image and paste it on the other.

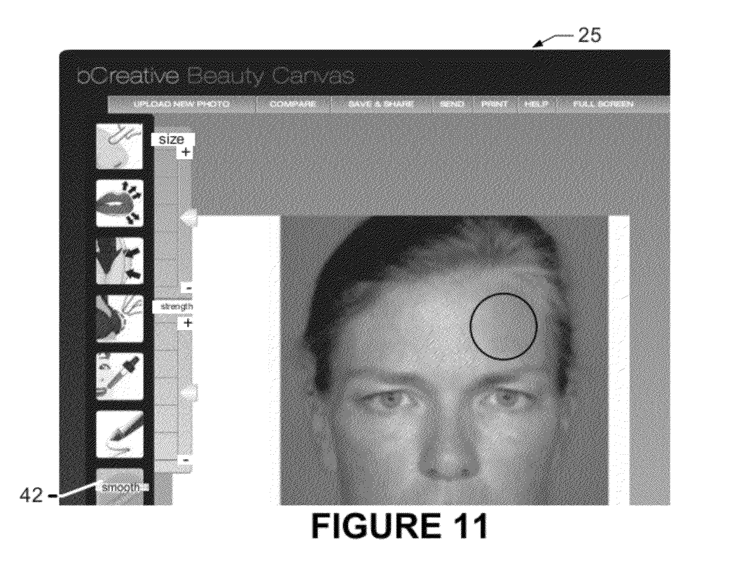

The sixth morphing tool, the draw tool 40, can be used to draw on the image, as shown in FIG. 10. Once the tool is launched, the practitioner can position the cursor over the part of the image that has the color the practitioner would like to use for the item to be drawn and selects that color. The practitioner can also select the size of the tip of the draw tool so as to allow the practitioner to draw a thicker or thinner line, etc. (e.g., a thicker tip size allows the practitioner to draw a thicker line). Thus, the practitioner can select a contrasting color to draw markings on the image. Or, the practitioner can use the draw tool to manipulate the image to remove brown spots (by drawing over those darker spots with a lighter skin color selected from the image). Thus, this draw tool allows a practitioner to select a size and color from the picture and then use it to encircle areas of the image, write on it, point to certain features, delete certain features, etc.

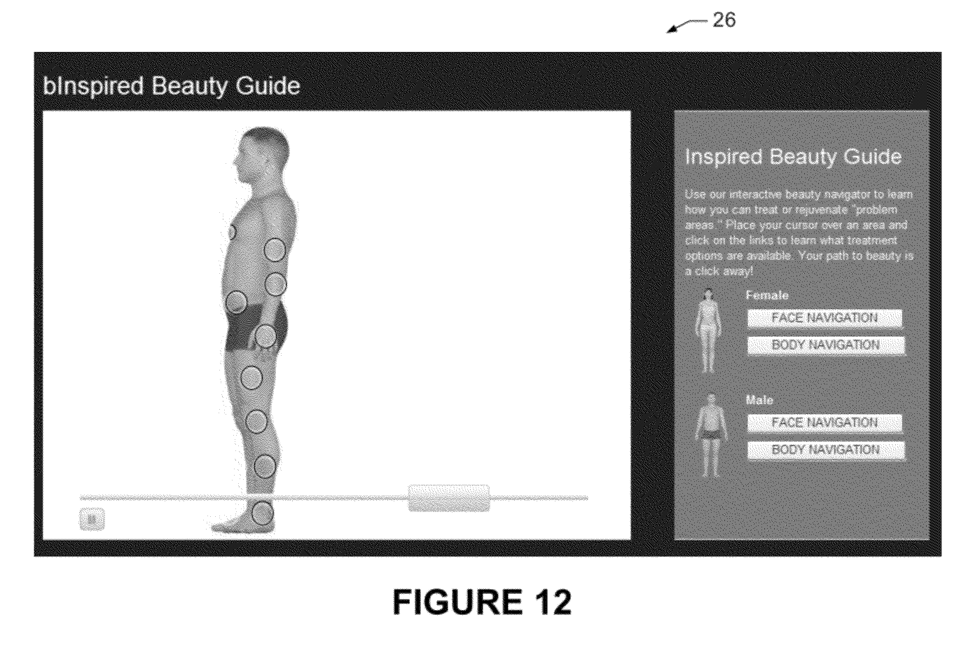

The seventh morphing tool, the smooth tool 42, can be used to smooth areas of the image, as shown in FIG. 11. Once selected, the smooth tool allows the practitioner to smooth out the colors of the skin, remove wrinkles, etc. Upon launch, the practitioner can select the size of the circle/region to be smoothed over and the strength of the smoothing. A low selected strength can lightly blur colors together, whereas a higher strength will provide more smoothing. The practitioner positions the circle cursor on the region to be smoothed over and can click until the desired smoothness is achieved.

The eighth morphing tool (not shown), the commenting tool, can be used to add typed comments, annotations, and/or other markings to the photographs. Other suitable tools can be provided as well. For example, the following additional tools can be provided: a cropping tool that allows the practitioner to crop image, a drawing tool that makes a smooth line, a tool that shows the effect of removing skin from the upper eyelid as one would see after a blepharoplasty, and a tool to mimic the effects of hair restoration surgery. A help menu can also be provided that includes a description of each tool and how to use it. Additionally or alternatively, the help menu can include videos showing the practitioner how to use each tool to achieve the desired effect.

The practitioner can use multiple tools to manipulate each image or can use a single tool. If the practitioner does not like the results of one or more manipulations, the practitioner can select an “undo” feature and try again. In other words, there can be an optional feature to take the practitioner back to the original image or to undo certain manipulations. Moreover, although a typical commercial embodiment provides for a circular area to be manipulated, other suitable shapes can be used as well (e.g., squares, rectangles, triangles, polygons, ovals, etc.). Fewer or additional morphing tools can be provided to the practitioner as well.

Referring back to FIGS. 4A-4C, the method 100 advances through steps 122 through 136 for each practitioner. Once the practitioner is happy with one or more manipulated images (as the practitioner may provide more than one image to the user to provide the user options), the practitioner can click a button to save the manipulated image(s) in at least one of the databases 18, and at step 122 the application 22 saves the image(s) in at least one database 18. Optionally, the practitioner can compare the manipulated image to the original image submitted by the user by selecting a “compare” feature. This selection can result in a side-by-side comparison of the two images. Optionally, the practitioner saves the image(s) with notes about the patient, procedure, etc. The notes may be transmitted to the user as practitioner comments to the user, or the practitioner can specify that the notes are to be saved in the practitioner account for his/her future use (and not be sent to the user). In some embodiments, a practitioner may choose to not use the morphing tool 25 provided, but rather use another suitable morphing tool, such as another commercially available morphing software application, to manipulate the photograph and then upload the photograph to the application 22. Still alternatively, a practitioner may choose not to manipulate the photograph at all, but rather would prefer to communicate with the user in writing such as by explaining thoughts regarding potential results (without actually showing those results in a picture). The practitioner can save those comments in the database and transmit that to the user. For example, the practitioner can render an opinion as to the likely success of the cosmetic procedure. Once the manipulated images and/or comments are saved, the application 22 transmits the practitioner response(s) to the user at step 124. Each response can include the images morphed by the practitioner and/or comments, options, opinions, etc. from the practitioner. It is envisioned that while typically, practitioners will use the morphing application to manipulate the user's photograph(s), in other embodiments, the practitioners may not use the morphing application 25 to manipulate the photograph, but rather will choose to provide a written description of what can be accomplished and how. The response can be sent automatically upon the practitioner saving the image(s) or comment(s). Alternatively, the practitioner can click a button within the application to transmit the response to the user. In one example embodiment, the response is transmitted to the user account within the application 22, and optionally, the application 22 can send a notification email message to the user when the response is ready for viewing. In another example embodiment, the response is transmitted to the user via email. Each email can include the response from a single practitioner, or the application 22 can batch the response from multiple practitioners together and send the user a combined email.

In an example embodiment, the user sees the responses in his/her account. Preferably, when images are sent as part of the response(s), the user sees those images in a gallery view so that the user can see the images from the various practitioners side-by-side and compare them to one another and to the original photograph. Once the user reviews the image(s) and/or comment(s) from the plurality of practitioners, the application 22 gives the user the option to request revisions to the images at step 126. At decision 128, if the user desires revisions to any of the images, then the application 22 at step 130 prompts the user to input a revised request. For example, the user can insert text requesting the feature manipulated be smaller, larger, a different shape, etc. The request can also include a selection of which practitioner(s) to send the revised request. For example, the user may choose to correspond with some or all of the practitioners who submitted a response with or without a manipulated image. The user may send each practitioner a different message with different instructions, or the instructions may be the same or substantially the same. In the case where the practitioner chose not to send a morphed image, the user can still continue corresponding with that practitioner, such as by asking additional questions or requesting additional information. Then at step 132, the application 22 transmits the revised request to the practitioner(s) selected by the user. Similar to the original request, the revised request can be transmitted to each practitioner account, or the revised request can be transmitted to the practitioners via email.

Then, the method 100 goes back to decision 118, where the application 22 determines whether the practitioner accepted the revised request. If the practitioner accepted the request, then steps 120 to 128 are repeated until the user is happy with the results and has not requested any further revisions. Once the user has not requested any further revisions to the image(s) (or responses) from the practitioners, then at step 134, the application 22 prompts the user to select a preferred practitioner, e.g., a practitioner with whom the user would like to engage further. This can occur by the user clicking on the profile name or picture of the preferred practitioner. In some cases, the user may want to schedule an in-person appointment with the preferred practitioner (and the in-person appointment would typically be at each practitioner's principal place of business). The user can select more than one preferred practitioner. For example, the user may want to continue corresponding with two or more practitioners and may even schedule in-person appointments with two or more practitioners. At this point, the user's identity and contact information can be provided to the preferred practitioner(s). In another embodiment, the application 22 can interface with the practitioner's scheduling system so that the user can schedule an appointment online. Alternatively, the application 22 may transmit an appointment request to the practitioner (such as to the practitioner account) with one or more desired dates and times for an appointment. Still alternatively, the appointment request can be transmitted to the practitioner via email. Still alternatively, the application can provide the user with the practitioner's contact information so that the user can reach out to the practitioner directly. Once the application 22 has confirmed that a selection of the preferred practitioner(s) made by the user, the application 22 optionally charges the preferred practitioner(s) a referral fee at step 136. In a typical commercial embodiment, each practitioner is charged for a patient contacting him/her to request an appointment (rather than charging the practitioner for an actual appointment). Alternatively, the application 22 can charge each practitioner a fee once the initial request is made. In an example embodiment, the user can continue corresponding with the preferred practitioner(s) over time and for future inquiries, and these preferences (for preferred practitioners) can change over time.

Additionally, the beauty tools application 22 can allow the user to manipulate his/her own photographs to mimic the results of a cosmetic procedure. For example, some or all of the tools available to the practitioners can also be made available to the user to morph his/her own photograph. The user may want to try morphing his/her own photograph before contacting the practitioners. Additionally, the user can transmit his/her own morphed photograph/image to the practitioners along with his/her original photograph to get an opinion from the practitioners as to whether to such results shown in the user's morphed photograph(s) are achievable. Additionally or alternatively, the user can save and share the morphed image by selecting a “save and share” feature. For example, the image can be saved locally on the user device 12 and/or it can be saved in the database 18 (e.g., included in the user account). The user can share the image by, for example, posting the image publicly on a website. Alternatively or additionally, the user can send the image via email (by selecting a “send” feature) to one or more practitioners, family members, friends, or others. Alternatively or additionally, the user can print the image to a selected printer (by selecting a “print” feature).

In other embodiment, the user can track the status of his/her request to the practitioners in a planning screen. For example, once the practitioner opens the user request, the application 22 can notify the user that the request has been reviewed. When the responses are available, the application 22 can notify the user of the same. Optionally, the user can also track the appointments and progress through the planning screen. Thus, the user can track his/her progress with a particular procedure or series of procedures.

In some example embodiments, the beauty tools application can provide the user information about cosmetic procedures, such as details about the procedure and/or videos showing the procedure. Optionally, the user can be prompted to provide payment information for utilizing some or all of the services of the application 22.

Thus, the application 22 provides the user the ability to start a relationship with a selected practitioner via a remote consultation and start the process for receiving the desired cosmetic procedure. This relationship can be continued well beyond the initial remote consultation and procedure. For example, the user can contact the practitioner for future consultations for additional procedures or to ask post-procedure questions.

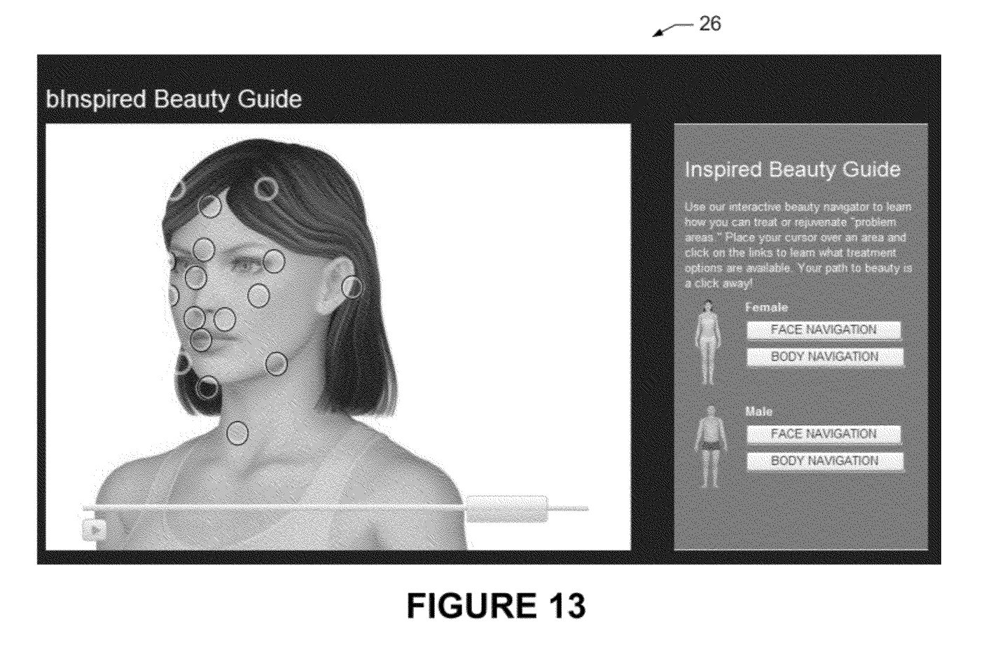

The beauty tools application 22 can also include a beauty guide application 26, as shown in FIGS. 12 and 13, that provides users with detailed information about cosmetic procedures. The beauty guide application 26 provides the user the option of selecting a navigation of the face or body of a male or female subject. FIG. 12 shows an interactive 3D or perspective image of a body navigation of a male subject. The image of the male subject rotates or spins about a longitudinal/long axis such that the user can select any of the “hot spots” designated on the front, sides, or rear of the body (e.g., hot spots can be located on the chest, thighs, calves, ankles, etc.). FIG. 13 is similar to FIG. 12, but a female face navigation is shown. The image rotates about the longitudinal axis, and hot spots can be selected by the user. In a typical commercial embodiment, the application 26 provides both male and female subjects for both the body and face navigations. The “hot spots” are designated by circles in the depicted embodiment, although any other suitable indicia can be used as well. Alternatively, no indicia are used so that the user just selects a portion of the image. Upon a selection of a desired hot spot, the application 26 displays a pop-up menu of procedures that are typically done on that region. The user can select any of the procedures to receive more information about that procedure. For example, if the user selects the hot spot over the knee of the male subject, a menu listing, for example, laser blood vessel removal, liposuction, and vein therapy (i.e., the procedures typically done in that region) is displayed. If the user selects the hot spot near one eye of the female subject, a menu listing, for example, eyelid surgery, brow lift, fat transfer, wrinkle filler, etc. (i.e., the procedures typically done in this region) is displayed. From this pop-up menu, the user can select a desired procedure such as by clicking on it. Doing so causes the application 26 to launch another window with detailed information about that procedure. Alternatively, the information can be shown in the same pop-up window. The detailed information can include information related to the particular condition and treatment, such as in the form of articles. The detailed information can also include videos and/or photographs (or other media) showing certain procedures being performed on a live subject. The detailed information can further include financing information for that procedure and a glossary. Additionally, if suitable beauty products exist for treating that condition, the detailed information can include a listing of those beauty products.

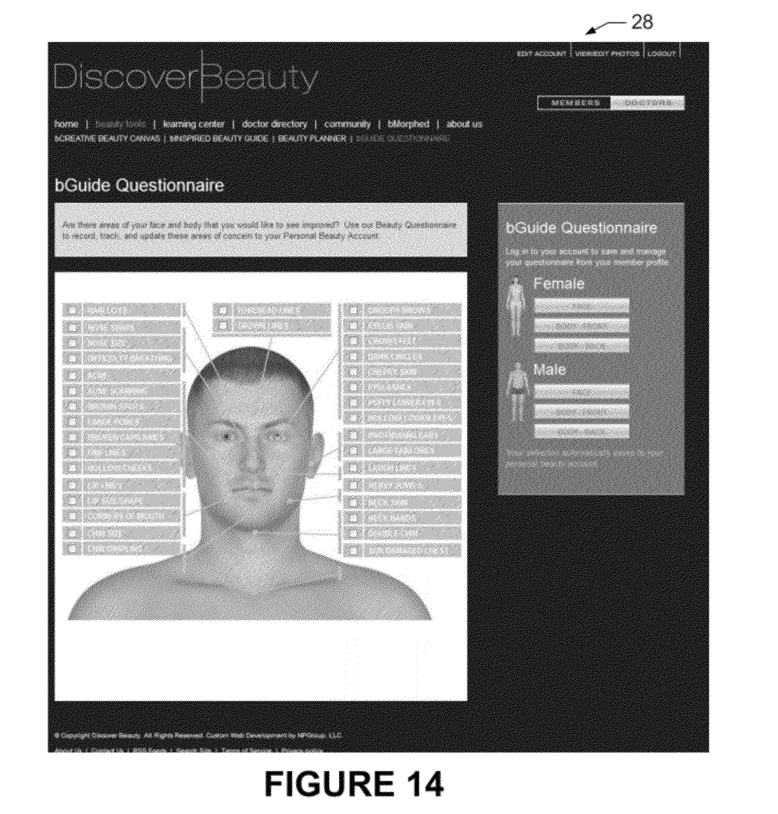

The beauty tools application 22 can also include a user questionnaire 28 that provides the user the ability to select portions of the body/face that the user would like to improve, as shown in FIG. 14. Selecting certain procedures automatically saves them in the user profile that the user created upon registration. The user can then use those saved procedures to initiate a request to one or more practitioners.

FIG. 14 shows a questionnaire for a male face, but in a typical commercial embodiment, there is also a questionnaire for a male body, female face, and female body.

The beauty tools application 22 can further include a member community (not shown) for peer-to-peer communications. This tool can allow users to connect to other users of the system 10 and can include discussion boards, etc.

Additionally, the beauty tools application 22 can provide practitioners additional features or other applications 29. Preferably, the application 22 provides each practitioner a practice page where the practitioner can manage patients and appointments. For example, the practice page can include a link to consultation requests, appointments, clients, email patients, invite patients, and morph requests. Additionally, the practice page can include a practice snapshot. The practice snapshot can include, but is not limited to, the number of clients or potential clients (e.g., users) using the application, the number of current patients that are invited to be clients of the application, the number of emails sent, the number of upcoming appointments, the number of appointments scheduled for today, the number of pending consultation requests, the number of morph requests, and the number of blog posts. This list of information can also include hot links to detailed information in the practitioner's practice page, as discussed in more detail below.

The consultation requests page can provide the practitioner the ability to contact current patients, users of the application 22, or potential new users of the application 22. For example, the practitioner can send a user a request to provide a consultation (for example, if the practitioner reviewed a publicly available portion of the user account). The request can appear in the user account, for example, or the request can be emailed to the user. The user can approve or deny that request. Thus, the consultation requests page can include a listing of all requests made by the practitioner as well as any approved, denied, or waiting approval, and links to the requests.

The patients or clients page can include a listing of all of the practitioner's patients, along with their contact information and photograph(s). This information is typically stored on one or more of the databases 18 and can be accessed by the practitioner via this patients web page. The patients can include the users of the application 22 that have selected the practitioner as his/her preferred practitioner, as well as the practitioner's patients who are not users of the application 22. If the patients are not users of the application 22, the practitioner can add those patients, their information, and their pictures to the database 18. The listing of patients can be arranged alphabetically by last name or in any other suitable order. Optionally, the listing can include a picture of the patient next to the name. Preferably, clicking on the picture or the name provides additional details about the patient. Such details can include the patient's contact information, photographs, past procedures, future scheduled or desired procedures, etc. Additionally or alternatively, if the patient is a user of the application 22, clicking on the patient's name or photograph can link to the user's profile page or a selected portion thereof made viewable to practitioners.

The appointments page can include tabbed screens, wherein the first tabbed screen can include a listing of today's appointments, the second tabbed screen can include a listing of upcoming appointments, and the third tabbed screen can include a listing of past appointments. Preferably, the appointments are listed chronologically. Clicking on any of the appointments in the list can provide details about the appointment. Such details can include the patient's name, time of appointment, reason for the appointment, and location of the appointment. Additionally, the appointments page can include the patient's contact information and/or links to contact information on the clients page. Moreover, the appointments page can include one or more photographs of the user (e.g., the original photograph, any morphed photographs, etc.) or links to such photographs.

The email patients page can provide an email box to email patients directly from the application 22. Such emails to and from the patients can be stored on the email patients page. The email patients page can include standard email functionality, as well as other standard features, including but not limited to an address book, spell checker, etc.

The invite patients page can include an interface to invite patients to become users of the web-based system. For example, the practitioner can input one or more email addresses to send a standard email inviting his/her patients to use the web-based system. Optionally, the email can be customized for each patient.

The morph requests page can include morph requests submitted by users of the application 22. For example, there can be a first tabbed screen showing a listing of new morph requests (e.g., requests that have not been completed). A second tabbed screen can include a listing of existing morph requests (e.g., requests that the practitioner has completed). The practitioner can choose to view more details about the request or can morph/revise the image. If the practitioner chooses the option to view additional details, the application 22 can link the practitioner to a page having details such as the user's name, any additional photographs the user provided, information about what the user wants to accomplish (e.g., remove sun spots, shrink the nose, etc.). This page can also include a side-by-side comparison of before and after photographs. From here or from the morph requests page, the practitioner can choose to morph now. Clicking on this option launches the morphing application 25 as described above.

Thus, the system 10 provides each practitioner a client relations and management tool. For example, the practitioner can follow-up with the user/patient after the procedure to check on the status and to answer any questions. Additionally, the practitioner can use the tools of the system 10 to reach out to a plurality of patients/users to advertise new services, etc. In other words, the practitioners can contact past, current, and future patients through the system 10 and exchange messages with morphed photographs.

The beauty tools application 22 can provide the practitioners further tools, such as a learning page with links to articles, procedures (e.g., to learn more about specific procedures), products, videos, and files. Such files can include files related to those areas typically used in practice, including but not limited to finances (e.g., income-expense statements, balance sheets, etc.), marketing (e.g., newsletter, seminar questionnaire, off site seminar checklist, in office seminar checklist, email blast, etc.), nursing (e.g., discharge forms, treatment plans, consent forms, post-operative instructions, pre-operative instructions, medication calendar, etc.), patient care (e.g., surgical quote, surgical revenue calendar, surgical pipeline, recall letter, consultation no procedure scheduled letter, surgical availability letter, thank you letter, follow-up letter, etc.), patient management (e.g., beauty checklist, HIPAA consent forms, photo release forms, registration forms, etc.), and staff and human resources (e.g., practice policy and procedure binder, practice manual, employee dismissal forms, training guides, new hire checklists, discipline forms, time off request forms, evaluation forms, job descriptions, etc.). In other words, the learning and practice page can provide the practitioners information about medical procedures as well as provide business information typically needed to run a successful medical practice.

Additional information related to building and maintaining a successful medical practice can be included a practice management page. For example, there can be a link to information (e.g., blogs, articles, etc.) relating to legal aspects of practicing medicine, including malpractice insurance. This page can also include a link to business applications. Business applications generally include applications or calculators that can benefit the financial side of the business. One beneficial calculation is a return on investment (“ROI”) calculation for comparing the expenses of using the system 10 of the present invention versus the additional income received by using the system 10. The system 10 can track the amount it has charged a particular practitioner and compare that to historical averages for the number of patients who actually follow through with receiving a procedure and average costs for such procedures. In another embodiment, the practitioner, or a member of his/her staff, can input the number of patients who actually received the requested procedure and the dollar amount charged. Then the system 10 can compare that inputted data to what it charged the practitioner. Thus, the ROI calculation provides the practitioners valuable advice regarding their marketing efforts through the system 10 of the present invention.

Other business applications can include a lease calculator, other return on investment calculators, an operating ratio application, a profitability application, a sensitivity analysis application, a conversion rate application, a retention rate application, a marketing budget application, and a support staff application. These application can provide the practitioners valuable tools for assessing their business.

Additionally, the practitioner account can include a link to the practitioner directory. Moreover, the practitioner can also have access to his/her own directory information. In an example embodiment, the practitioner can update his/her own contact information, practice information, bio information, and educational information in his/her practitioner account, and doing so can automatically update the information in the practitioner directory. The practitioner can also list the cosmetic procedures he/she performs as well as the products he/she recommends.

Other features of the present invention provide the practitioner the ability to write blogs and contribute articles and/or vides to the system 10. Additionally, practitioners can correspond with each other through a practitioner to practitioner web page. Thus, practitioners can seek advice of colleagues and render advice to colleagues.

Referring back to FIG. 1, when the applications 22 and 25 are implemented in software, it should be noted that the applications can be stored on virtually any computer-readable medium for use by or in connection with any computer related system or method. The system can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but is not limited to, an electronic, magnetic, optical, electromagnetic, infrared, or semiconductor system, apparatus, device, or propagation medium.

More specific examples (a non-exhaustive list) of the computer-readable medium include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In an alternative embodiment, where the applications 22 and 25 are implemented in hardware, the system can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In an example embodiment, the applications 22 and 25 are stored in the memory of one or more servers 16a-16n. Each server's processor is a hardware device for executing software that can be stored in memory. The processor can be virtually any custom made or commercially available processor, a central processing unit (CPU), data signal processor (DSP) or an auxiliary processor among several processors associated with the server, and a semiconductor based microprocessor (in the form of a microchip) or a macroprocessor.

When one or more of the servers 16a-16n are in operation, the processor is configured to execute software stored within the memory, to communicate data to and from the memory, and to generally control operations of the server pursuant to the software. The system and the O/S are read, in whole or in part, by the processor, perhaps buffered within the processor, and then executed.

The memory can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory may incorporate electronic, magnetic, optical, and/or other types of storage media. Note that the memory can have a distributed architecture, where various components are situated remote from one another but can be accessed by the processor.

The software in memory may include one or more separate programs, each of which comprises an ordered listing of executable instructions for implementing logical functions. The software in the memory can include a suitable operating system (O/S) and the system of the present invention. As illustrated, the system of the present invention can comprise numerous functional tools including, but not limited to, the beauty applications tool, the morphing tool, a calendaring tool, etc.

The applications and method can be implemented on an ADOBE FLASH® platform or other suitable platform. In other forms, the applications and method can be embodied as an application for a handheld device such as a mobile phone (e.g., APPLE® IPHONE®, or other smart phone) or other mobile computing device (such as an APPLE® IPAD® or other tablet computer).

The operating system essentially controls the execution of other computer programs, such as the applications 22 and 25, and provides scheduling, input-output control, file and data management, memory management, and communication control and related services. However, it is contemplated by the inventors that the system of the present invention is applicable on all other commercially available operating systems.

The applications 22 and 25 of the present invention may be a source program, executable program (object code), script, or any other entity comprising a set of instructions to be performed. When a source program, then the program is usually translated via a compiler, assembler, interpreter, or the like (which may or may not be included within the memory) so as to operate properly in connection with the O/S 51. Furthermore, the web-based system can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

If the servers 16a-16n are PCs, workstations, intelligent devices or the like, the software in the memory may further include a basic input output system (BIOS). The BIOS is a set of essential software routines that initialize and test hardware at startup, start the O/S 51, and support the transfer of data among the hardware devices. The BIOS is stored in some type of read-only-memory, such as ROM, PROM, EPROM, EEPROM or the like, so that the BIOS can be executed when the server is activated.

While the invention has been described with reference to example embodiments, it will be understood by those skilled in the art that a variety of modifications, additions, and deletions are within the scope of the invention, as defined by the following claims.

What is claimed is:

1. A cloud-based system that enables users to choose from among a plurality of medical practitioners, comprising:
a plurality of cloud-based computer servers connected to the internet and in communication with one another, wherein computer-executable instructions reside on one or more of the servers, the computer-executable instructions including:
instructions for receiving a request from a user device to change the appearance of at least one body part of the user, the request including a photograph of the body part and text describing what changes are desired, and the user device being connected to the plurality of computer servers via the internet;
instructions for sending the user's request to the plurality of medical practitioners via the internet;
instructions for receiving from at least one of the plurality of medical practitioners a response to the request, wherein the response includes a morphed image that is a morphed version of the user's submitted photograph to show the user's desired changes; and
instructions for sending the response to the user.

2. The cloud-based system of claim 1, wherein the response further includes a comment from the practitioner.

3. The cloud-based system of claim 1, further comprising instructions for providing the practitioners a plurality of tools within the cloud to manipulate the photograph.

4. The cloud-based system of claim 1, wherein the instructions for sending the user's request to the plurality of medical practitioners comprise instructions for transmitting the request to a plurality of practitioner accounts within the system, wherein each account is dedicated to a single medical practitioner.

5. The cloud-based system of claim 4, further comprising instructions for emailing each of the plurality of practitioners a notification of the user's request.

6. The cloud-based system of claim 1, wherein the instructions for sending the user's request to the plurality of medical practitioners comprise instructions for sending the request via email.

7. The cloud-based system of claim 1, wherein the instructions for sending the response to the user comprise instructions for sending the response to an account dedicated to the user.

8. The cloud-based system of claim 1, further comprising prompting the user to send an appointment request to one or more of the practitioners.

9. The cloud-based system of claim 8, further comprising instruction for charging a fee to the one or more practitioners who were sent the appointment request.

10. A method that enables users to connect with one or more medical practitioners prior to meeting the practitioners in person, comprising:
receiving a photograph over the internet from a user with a request to modify at least a portion of the photograph to achieve a desired goal;
transmitting the photograph and the desired goal to a plurality of medical practitioners;
providing a plurality of morphing tools to the plurality of medical practitioners to use to modify the photograph into the morphed version;
receiving a response from at least one practitioner, wherein the response comprises at least one of a morphed version of the user's photograph and a comment; and
transmitting the response to the user.

11. The method of claim 10, further comprising the step of receiving an appointment request from the user for an in-person appointment with at least one practitioner.

12. The method of claim 11, further comprising the steps of receiving a follow-up communication from the user after the in-person appointment, and transmitting the follow-up communication to the practitioner that was scheduled.

13. The method of claim 12, wherein the follow-up communication includes a second request from the user to the medical practitioner to morph a photograph to achieve a desired goal.

14. A computer-implemented system for providing a user a remote consultation from a medical practitioner, comprising:
logic for saving a request for the remote consultation from the user in a portion of a centralized database, wherein the portion of the centralized database is accessible by the medical practitioner and the user, wherein the request includes at least one photograph of the user and at least one change desired by the user, and wherein the centralized database is connected to the internet;
logic for providing the practitioner with tools for manipulating the photograph into a morphed electronic image, wherein the morphed electronic image reflects the desired change and wherein the tools are accessed through an application via the internet; and
logic for storing the morphed electronic image in the portion of the centralized database accessible by the user and the medical practitioner.

15. The computer-implemented system of claim 14, wherein a notification email is sent to the user when the morphed electronic image is saved in the database.

16. The computer-implemented system of claim 14, further comprising logic for associating user contact information with the user's photograph and storing the contact information in the centralized database.

17. The computer-implemented system of claim 16, wherein the preferred practitioner has access to the user's contact information.

18. A computer program for connecting users with a plurality of practitioners, the computer program being embodied on a computer-readable medium, the program comprising:
a first code segment for receiving a request from each user, wherein each request includes an image of the user and a description of the desired change to the image;
a second code segment for transmitting each request to a plurality of practitioners;
a third code segment for transmitting responses from at least two practitioners to each user, wherein each response includes a modified photograph and a comment; and
a fourth code segment for receiving a selection from each user of a preferred practitioner for future contact.

19. The computer program of claim 18, further comprising a fifth code segment for providing the plurality of practitioners one or more tools for manipulating the user's photograph into the modified photograph.

20. The computer-implemented system of claim 18, further comprising a sixth code segment for associating user contact information with each user's photograph and storing the user contact information in the centralized database.

21. The computer-implemented system of claim 20, wherein only the preferred practitioner has access to the user's contact information.

22. The computer-implemented system of claim 21, further comprising a code segment that allows the preferred practitioner to contact users for whom the practitioner has contact information.

23. A communications method for exchanging messages over the internet between a practitioner and a plurality of patients, the messages including one or more photographs, the method comprising:
receiving a request from the practitioner to access a centralized database connected to the internet, the centralized database having stored thereon information for the plurality of patients, the information including contact information for the plurality of patients and a first photograph of each of the plurality of patients, wherein the first photograph shows the patient prior to a particular procedure;
receiving a selection from the practitioner of contact information for one or more patients to whom a message will be sent; and
sending the message to the one or more patients, the message including a second photograph, wherein the second photograph shows projected results for the particular procedure.

24. The communications method of claim 23, further comprising the step of providing a morphing application with a plurality of tools to be used by the practitioner to morph the first photograph into the second photograph.

25. The communications method of claim 23, wherein the practitioner can add a patient's name, contact information, and photograph to the centralized database.
